(19) United States
(12) Patent Application Publication
(10) Pub. No.: US 2024/0236477 A1
(43) Pub. Date: Jul. 11, 2024

(54) CONTEXT-AWARE LIGHTING SYSTEM

(71) Applicants: Elizabeth Loretta Corso, Issaquah, WV (US); Vineet Kapil, Santa Monica, CA (US); Amit Patel, Seattle, WA (US); Bertrand Saint-Preux, Hollywood, FL (US)

(72) Inventors: Elizabeth Loretta Corso, Issaquah, WV (US); Vineet Kapil, Santa Monica, CA (US); Amit Patel, Seattle, WA (US); Bertrand Saint-Preux, Hollywood, FL (US)

(21) Appl. No.: 18/405,849

(22) Filed: Jan. 5, 2024

(30) Foreign Application Priority Data
Jan. 6, 2023 (IN) 202311001343

(51) Int. Cl. H04N 23/63; G06T 7/60; G06T 7/73; G06T 11/00; H04N 23/611; H04N 23/62

(52) U.S. Cl. CPC H04N 23/632; G06T 7/60; G06T 7/73; G06T 11/001; H04N 23/611; H04N 23/62; G06T 2200/24; G06T 2207/10024; G06T 2207/20092; G06T 2207/30201; G06T 2210/12

(57) ABSTRACT

A method and system causing presentation of a camera view user interface (UI) on a computing device. The camera view UI includes an output of a digital image sensor of a camera. The system detects a face in an image corresponding to the output of the digital image sensor of the camera. The system generates a ring light including a non-opaque portion and a portion of a color with a predetermined lightness. The non-opaque portion includes a ring shape with a ring size and a position determined based on an image portion including the detected face. The system computes RGBA color values for ring light pixels, each value comprising a RGB component computed using a base color and an opacity value computed using an inner radius, center offset coordinates, and/or a radial gradient computation. The system causes display of the ring light over the camera view UI.

### CROSS-REFERENCE TO RELATED APPLICATIONS

This application claims the benefit of priority to Indian Patent Application Serial No. 202311001343, filed on Jan. 6, 2023, which is hereby incorporated by reference in its entirety.

### TECHNICAL FIELD

The disclosed subject matter relates generally to the technical field of lighting systems and, in one specific example, to a context-aware lighting system.

### BACKGROUND

Many applications executing at a computing device provide a user interface (UI) that allows users to use a front-facing camera to see themselves, capture a photo of themselves, or potentially share the captured photo to other devices. Users are interested in using their cameras for such purposes in a variety of lighting conditions, and in a variety of scenarios involving one or more users and one or more user positions in photos.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system, according to some examples, that has both client-side and server-side functionality, and that includes a lighting system.

FIG. 3 is a diagrammatic representation of a data structure as maintained in a database, according to some examples.

FIG. 4 is a diagrammatic representation of a message, according to some examples.

FIG. 5 is a flowchart illustrating a process flow for a context-aware lighting system, according to some examples.

FIG. 6 is a diagrammatic representation of a view of a context-aware lighting system, according to some examples.

FIG. 7 is an illustration of lighting system outputs, according to some examples.

FIG. 8 is an illustration of lighting system outputs, according to some examples.

FIG. 9 is an illustration of lighting system outputs with different base colors, according to some examples.

FIG. 10 is an illustration of lighting system outputs with different ring sizes, according to some examples.

FIG. 11 is an illustration of an output of a face detection and/or tracking module, according to some examples.

FIG. 12 is an illustration of lighting system outputs, according to some examples.

FIG. 13 is an illustration of different ring sizes corresponding to a detected face, according to some examples.

FIG. 14 is a diagrammatic representation of an example time-based access architecture, according to some examples.

FIG. 15 is a diagrammatic representation of a machine in the form of a computer system within which a set of instructions may be executed to cause the machine to perform any one or more of the methodologies discussed herein, according to some examples.

FIG. 16 is a block diagram showing a software architecture within which examples can be implemented.

### DETAILED DESCRIPTION

Many applications executing at a computing device provide a user interface (UI) that allows users to use a front-facing camera to see themselves, capture a photo of themselves, share the captured photo with other devices, or include it in a messages or conversations with friends or connections. Such uses can take place in a variety of lighting conditions, and in a variety of scenarios involving one or more users and one or more user positions in photos.

Photos taken in low light or dark conditions can be of poor quality, which results in discarded photos, or abandoned user sessions. Furthermore, a photo can include one or more users, who may or may not be centrally located. Previous example solutions for enhancing the quality of images captured by a camera in low light conditions have involved automatically increasing the brightness of the display subsequent to detecting low light conditions or subsequent to a request from the user, the use of a front flash view or the use of a ring light or ring flash that adds illuminating borders to the viewfinder of a camera, and other solutions. However, these solutions have limitations. For example, a ring light that adds illuminating borders to the viewfinder of a camera can result in the user's face being partially or completely occluded if the face is not centrally located. When multiple users are present within the field of view, one or more faces will likely be occluded.

Examples in the disclosure herein refer to a context-aware lighting system that addresses these technical problems by using context provided by face detection and/or tracking functionality to automatically configure lighting or illumination to surround and/or not occlude the faces of the one or more users in the frame. The context-aware lighting system generates a ring light (or ring flash) displayed in, or over, the viewfinder of a camera such as a front-facing camera. By dynamically adjusting the ring light based on real-time face detection, lighting conditions can be set automatically before or during image capture, thus enhancing the user experience and/or image quality without the need for external equipment or post-processing.

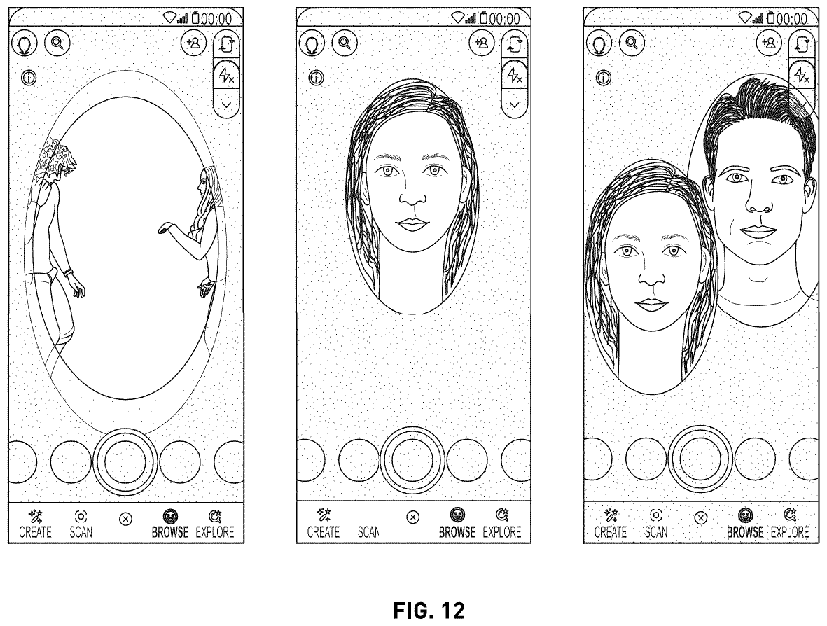

In some examples, the ring light has a non-opaque portion. In some examples, the non-opaque portion is fully or almost fully transparent. In some examples, the ring light includes a portion with a color of a predetermined lightness (e.g., an illuminating border or illuminating portion) displayed over an area of the camera view UI, such as along the perimeter, surrounding the non-opaque portion, and/or in other areas of the camera view UI. The ring light can be configured based on the output of a face detection and/or tracking module that detects one or more faces in the image corresponding to the output of the digital image sensor of the camera (see, e.g., FIG. 12). By using face detection and/or tracking context, the context-aware lighting system can ensure that the detected faces are not occluded by the ring light.

In some examples, the non-opaque portion of the ring light includes a ring shape with an associated ring size. The ring size can be automatically determined based on characteristics of an image portion corresponding to a detected face, thus ensuring that the detected face is not occluded by the ring light. The ring size can be determined based on an inner radius computed based on coordinates of automatically detected facial landmarks corresponding to the detected face. The ring size can be further computed using one or more scale factors. In some examples, the non-opaque portion of the ring light is centered using a set of coordinates (e.g., a set of center offset coordinates) determined based on the coordinates of the automatically detected facial landmarks.

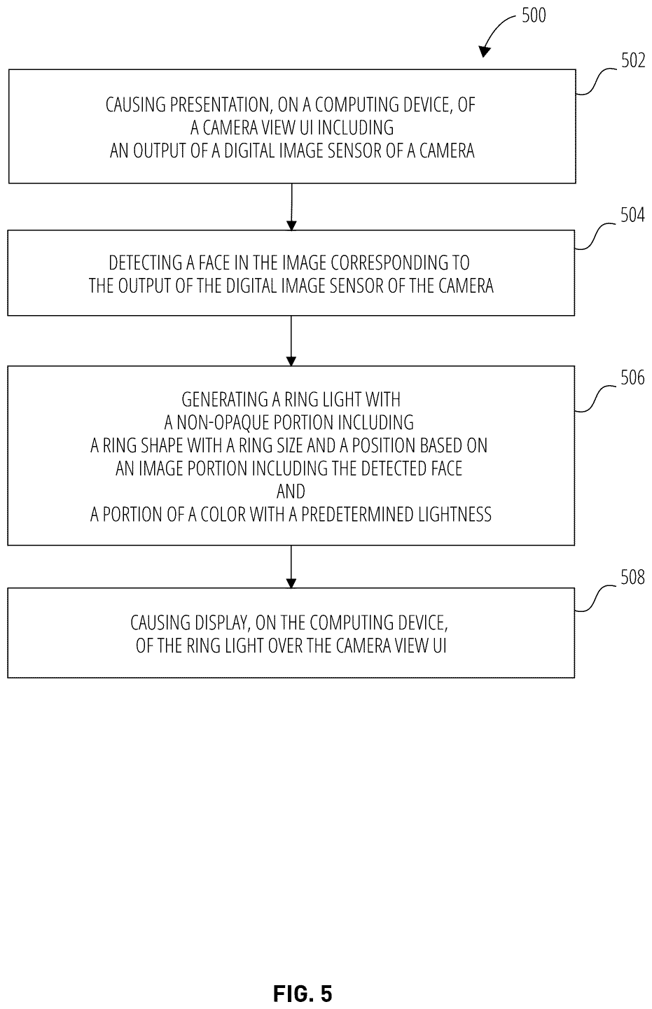

In some examples, the ring light includes a portion of a color with a predetermined lightness or brightness (see at least FIG. 5 for details). Lightness defines a range from dark (0% or fully shaded) to fully illuminated (100% or fully tinted). The ring light can be configured to have pixels with varying lightness levels and/or varying colors.

In some examples, generating the ring light can include computing a RGBA color value for multiple ring light pixels, the RGBA color value for each pixel comprising a RGB component value and an opacity value. The RGB component value can be computed using a supplied base color. The opacity value can be computed using at least one of an inner radius, the set of center offset coordinates, or a radial gradient computation. Therefore, the ring light can be configured to have pixels with varying opacity levels.

In some examples, a second face is detected in the image corresponding to the digital image sensor of the camera. The ring light comprises a second non-opaque portion and/or a second portion of a second color with a second pre-determined lightness. The second non-opaque portion includes a second ring shape with an associated second ring size and/or position. The second ring size and/or position can be automatically determined based on characteristics of a second image portion corresponding to the second detected face.

In some examples, the ring light is enabled to be configurable by a user via by the selection of one or more parameters. Example parameters include a base color, a ring size, a ring shape, a scale factor, a texture type, and so forth. In some examples, a ring light can be automatically generated and/or presented in the camera view UI when the digital sensor of a front-facing camera detects a low light indication based on the intensity of incident light detected by the digital image sensor of the camera. In some examples, when the digital sensor of a front-facing camera detects a low light indication, a user-selectable element, such as a night-mode selectable element, is presented in the camera view UI. A user can activate a ring light by engaging the night-mode selectable element.

In some examples, the ring light can be implemented and/or rendered using the camera of a computing device. For example, the ring light can be constructed as a single view overlaid over the camera view UI that displays the output of a digital image sensor of a camera. In some examples, the ring light can be constructed using multiple views, such as one for each side of the camera view UI, where each view is overlaid over a respective area along the perimeter of the camera view UI. In some examples, the ring light can be implemented using AR components and/or experiences and/or AR tools or functionality. For example, the ring light can be implemented as a customizable ring light lens. In some examples, the ring light can be implemented and/or rendered using a mix of camera-related functionality and AR functionality.

### Networked Computing Environment

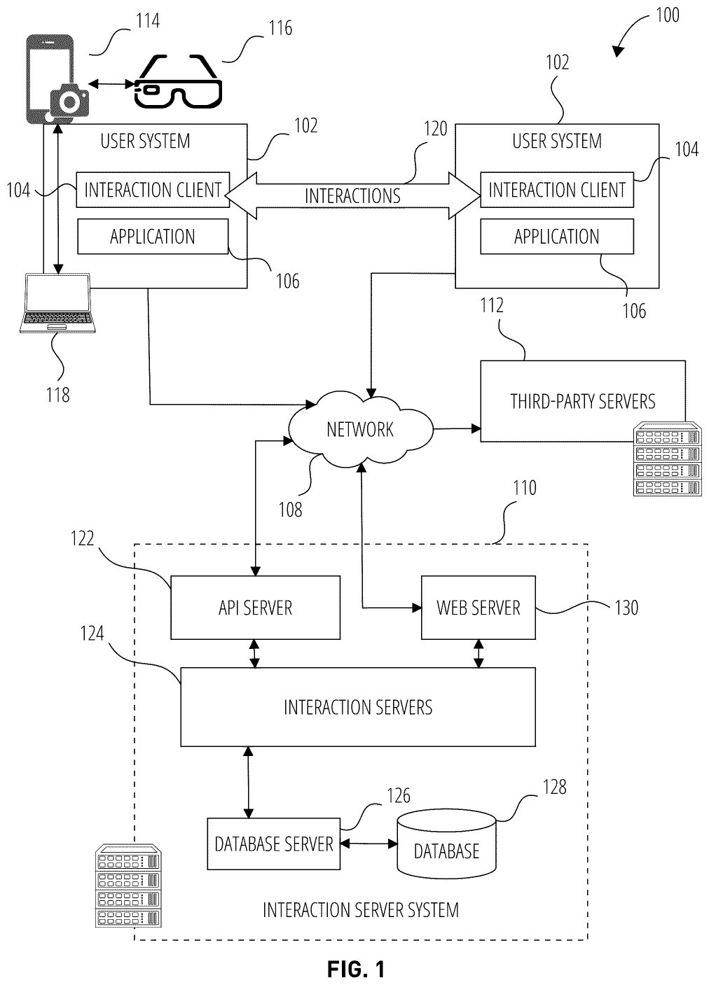

FIG. 1 is a block diagram showing an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple computing devices or user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

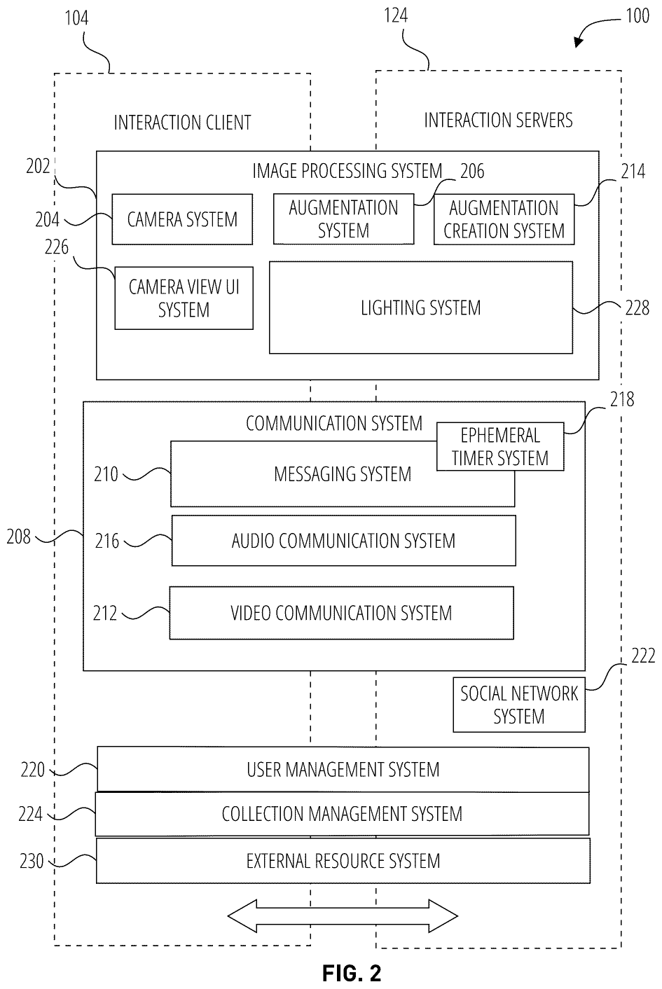

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. Example subsystems are discussed below.

The camera view UI system 226 is configured to cause presentation of a camera view UI, which displays the output of a digital image sensor of a camera provided with an associated computing device such as a client device, as well as user selectable elements that permit users to invoke various functionality related to the operation of the camera. For example, the camera view UI system may generate user selectable elements that can be engaged to capture the output of the digital image sensor of a camera as an image, to start and stop a video recording, to switch between a rear camera and a front facing camera, as well as other user selectable elements.

The lighting system 228, which can be included in or incorporated in the camera view UI system 226, can be configured to receive or generate an image corresponding to the output of a digital image sensor of a camera provided with an associated computing device. The lighting system 228 generates and/or customizes lighting by generating, for example, a ring light or ring flash. In some examples, the lightning system 228 is a context-aware lighting system. The examples in the disclosure herein refer to examples of such a context-aware lighting system 228 and/or examples of corresponding generated ring lights.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from a memory of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

In some examples, the augmentation system 206 is configured to provide access to AR components that can be implemented using a programming language suitable for application development, such as, e.g., JavaScript or Java and that are identified in the messaging server system by respective AR component identifiers. An AR component may include or reference various image processing operations corresponding to an image modification, filter, media overlay, transformation, and the like. These image processing operations can provide an interactive experience of a real-world environment, where objects, surfaces, backgrounds, lighting etc., captured by a digital image sensor or a camera, are enhanced by computer-generated perceptual information. In this context an AR component comprises the collection of data, parameters, and other assets needed to apply a selected augmented reality experience to an image or a video feed.

In some embodiments, an AR component includes modules configured to modify or transform image data presented within a graphical user interface (GUI) of a client device in some way. For example, complex additions or transformations to the content images may be performed using AR component data, such as adding rabbit ears to the head of a person in a video clip, adding floating hearts with background coloring to a video clip, altering the proportions of a person's features within a video clip, or many numerous other such transformations. This includes both real-time modifications that modify an image as it is captured using a camera associated with a client device and then displayed on a screen of the client device with the AR component modifications, as well as modifications to stored content, such as video clips in a gallery that may be modified using AR components.

Various augmented reality functionality that may be provided by an AR component include detection of objects (e.g. faces, hands, bodies, cats, dogs, surfaces, objects, etc.), tracking of such objects as they leave, enter, and move around the field of view in video frames, and the modification or transformation of such objects as they are tracked. In various embodiments, different methods for achieving such transformations may be used. For example, some embodiments may involve generating a 3D mesh model of the object or objects, and using transformations and animated textures of the model within the video to achieve the transformation. In other embodiments, tracking of points on an object may be used to place an image or texture, which may be two dimensional or three dimensional, at the tracked position. In still further embodiments, neural network analysis of video frames may be used to place images, models, or textures in content (e.g. images or frames of video). AR component data thus refers to both to the images, models, and textures used to create transformations in content, as well as to additional modeling and analysis information needed to achieve such transformations with object detection, tracking, and placement.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system 218) that, based on duration and display parameters associated with a message or collection of messages (e.g., a story), selectively enable access (e.g., for presentation and display) to messages and associated content via the interaction client 104. Further details regarding the operation of the ephemeral timer system 218 are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 220 is operationally responsible for the management of user data and profiles, and includes a social network system 222 that maintains information regarding relationships between users of the interaction system 100.

A collection management system 224 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 224 may also be responsible for publishing an icon that provides notification of a particular collection to the user interface of the interaction client 104. The collection management system 224 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 224 employs machine vision (or image recognition technology) and content rules to curate a content collection automatically. In certain examples, compensation may be paid to a user to include user-generated content into a collection. In such cases, the collection management system 224 operates to automatically make payments to such users to use their content.

An external resource system 230 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A WebViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

### Data Architecture

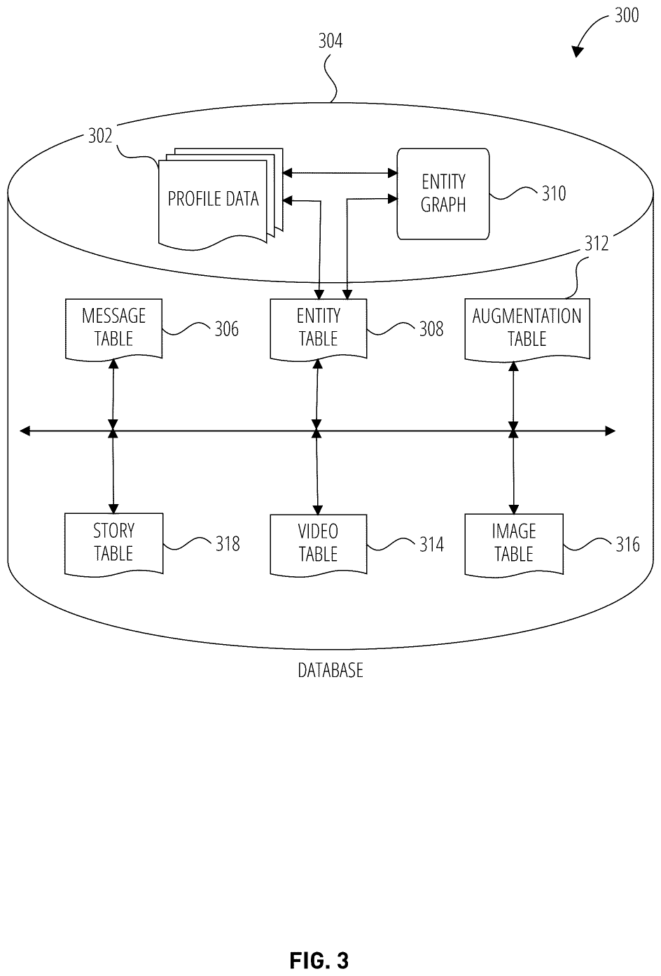

FIG. 3 is a schematic diagram illustrating data structures 300, which may be stored in the database 304 of the interaction server system 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message, and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video). In some examples, the augmentation data is used by various AR components, including the AR component. An example of augmentation data is a target media content object, which may be associated with an AR component and used to generate an AR experience for a user, as described above.

Another example of augmentation data is augmented reality (AR) tools that can be used in AR components to effectuate image transformations. Image transformations include real-time modifications, which modify an image (e.g., a video frame) as it is captured using a digital image sensor of a client device. The modified image is displayed on a screen of the client device with the modifications. AR tools may also be used to apply modifications to stored content, such as video clips or still images stored in a gallery. In a client device with access to multiple AR tools, a user can apply different AR tools (e.g., by engaging different AR components configured to utilize different AR tools) to a single video clip to see how the different AR tools would modify the same video clip. For example, multiple AR tools that apply different pseudorandom movement models can be applied to the same captured content by selecting different AR tools for the same captured content. Similarly, real-time video capture may be used with an illustrated modification to show how video images currently being captured by a digital image sensor of a camera provided with a client device would modify the captured data. Such data may simply be displayed as part of a preview feature (e.g., displayed on the screen and not stored in memory), or the content captured by digital image sensor may be recorded and stored in memory with or without the modifications (or both). A messaging client can be configured to include a preview feature that can show how modifications produced by different AR tools will look, within different windows in a display at the same time. This can, for example, permit a user to view multiple windows with different pseudorandom animations presented on a display at the same time.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated (e.g., using an Active Shape Model (ASM) or other known methods). Then, a mesh based on the characteristic points is generated for each of the at least one element of the object. This mesh used in the following stage of tracking the elements of the object in the video stream. In the process of tracking, the mentioned mesh for each element is aligned with a position of each element. Then, additional points are generated on the mesh. A first set of first points is generated for each element based on a request for modification, and a set of second points is generated for each element based on the set of first points and the request for modification. Then, the frames of the video stream can be transformed by modifying the elements of the object on the basis of the sets of first and second points and the mesh. In such method, a background of the modified object can be changed or distorted as well by tracking and modifying the background.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing color of areas; removing at least some part of areas from the frames of the video stream; including one or more new objects into areas which are based on a request for modification; and modifying or distorting the elements of an area or object. In various embodiments, any combination of such modifications or other similar modifications may be used. For certain models to be animated, some characteristic points can be selected as control points to be used in determining the entire state-space of options for the model animation.

A story table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

### Data Communications Architecture

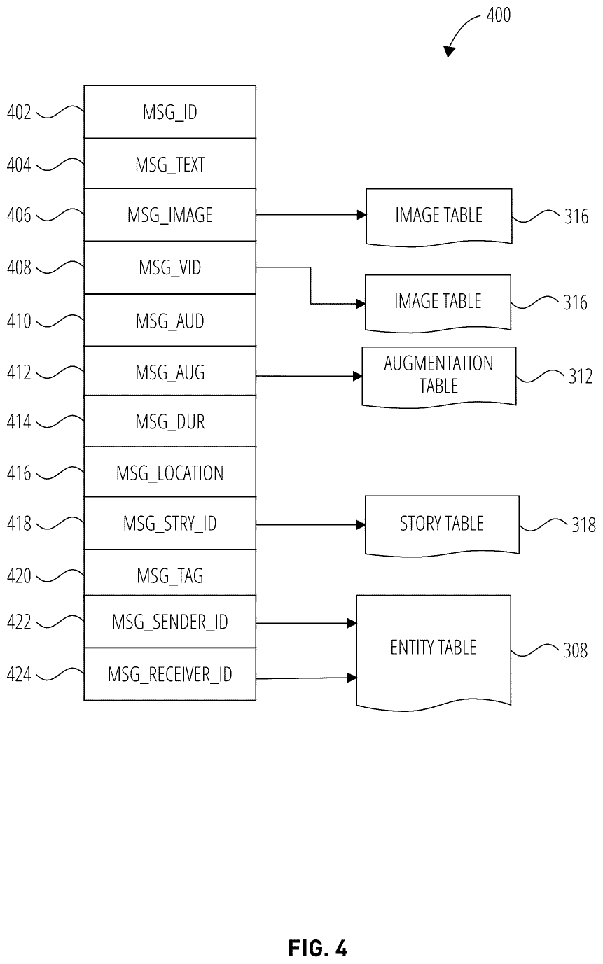

FIG. 4 is a schematic diagram illustrating a structure of a message 400, according to some examples, generated by an interaction client 104 for communication to a further interaction client 104 via the interaction servers 124. The content of a particular message 400 is used to populate the message table 306 stored within the database 304, accessible by the interaction servers 124. Similarly, the content of a message 400 is stored in memory as “in-transit” or “in-flight” data of the user system 102 or the interaction servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 316.
Message video payload 408: video data, captured by a camera component or retrieved from a memory component of the user system 102, and that is included in the message 400. Video data for a sent or received message 400 may be stored in the image table 316.
Message audio payload 410: audio data, captured by a microphone or retrieved from a memory component of the user system 102, and that is included in the message 400.
Message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 312.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message story identifier 418: identifier values identifying one or more content collections (e.g., “stories” identified in the story table 318) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 316. Similarly, values within the message video payload 408 may point to data stored within an image table 316, values stored within the message augmentation data 412 may point to data stored in an augmentation table 312, values stored within the message story identifier 418 may point to data stored in a story table 318, and values stored within the message sender identifier 422 and the message receiver identifier 424 may point to user records stored within an entity table 308.

### Process Flow and User Interfaces

FIG. 5 is a flowchart of a method 500 as implemented by a context-aware lighting system 228, according to some examples. In some examples, method 500 improves an image quality for an image previewed or captured by a camera of a computing device. The method 500 can be performed by processing logic that comprises hardware (e.g., dedicated logic, programmable logic, microcode, etc.), software, or a combination of both. Although the described flowchart shows operations as a sequential process, many of the operations can be performed in parallel or concurrently. In addition, the order of the operations may be re-arranged. The operations of methods can be performed in whole or in part, can be performed in conjunction with some or all of the operations in other methods, and can be performed by any number of different systems, such as the systems described herein, or any portion thereof, such as a processor included in any of the systems.

At operation 502, a computing device causes presentation of a camera view UI on a display device, or on the computing device (e.g., using the camera view UI system 226 of FIG. 2). The camera view UI comprises an output of a digital image sensor of a camera. In some examples, the camera view UI detects that the camera is a front-facing camera. In some examples, the camera view UI comprises a shutter element that can be selected by a user to capture the output of the digital image sensor of the camera.

At operation 504, the computing device analyzes the image corresponding to the output of the digital image sensor of the camera to detect a face. In some examples, the computing device uses a generic face detector to detect the face in the image. In some examples, the computing device uses a platform-specific face detector to detect the face in the image. The platform-specific face detector can be developed and/or customized for a specific platform. For example, a platform-specific face detector can be a vendor-provided face detector customized depending on the requirements of the platform. Examples of vendor-provided face detectors include those available from Google Mobile Services (GMS), Huawei Mobile Services (HMS), ML Kit, or other vendors. Such face detectors can automatically detect faces and/or corresponding bounding boxes while analyzing camera frames at an acceptable rate. In some examples, the computing device uses a generic face tracking module, or a platform-specific face tracking module. The platform-specific face tracking module can be developed and/or customized for a specific platform. The face detector module and the face tracking module can be provided by the same vendor or by different vendors. For example, the computing device can use a HMS face detector and a face tracking module available from Snap's Lens Studio. While operation 504 refers to a face detection operation, the computing device can use detection and/or tracking modules to detect and/or track other entities to be illuminated, such as an animal (e.g., a dog or a cat), a book, a utensil, a cosmetic product, and so forth.

At operation 506, the computing device generates a ring light that includes a non-opaque portion and/or a portion of a color with a predetermined lightness. The non-opaque portion includes a ring shape with an associated ring size and/or position. Illustrative examples in the disclosure herein refer to circle ring shapes or ellipse ring shapes, but “ring” refers, without loss of generality, to other shapes such as a circle, a ellipse, square, triangle, rectangle, star, diamond, or other shapes. In some examples, the ring shape with the associated ring size corresponds to an inner ring shape included in the non-opaque portion which can extend farther in one or more directions. In some examples, the non-opaque portion can have an inner ring shape and/or an outer ring shape of the same or different shape types.

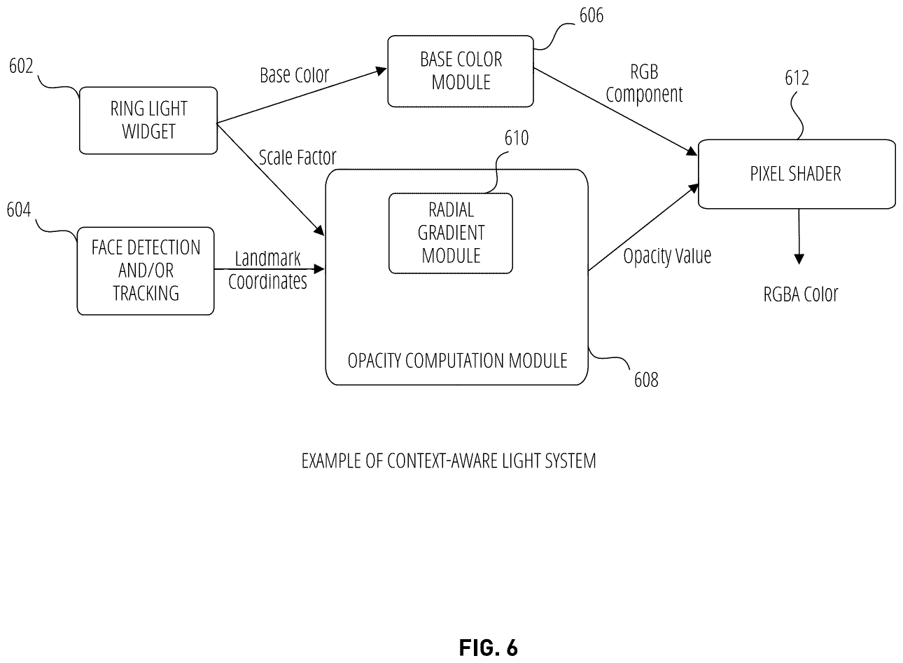

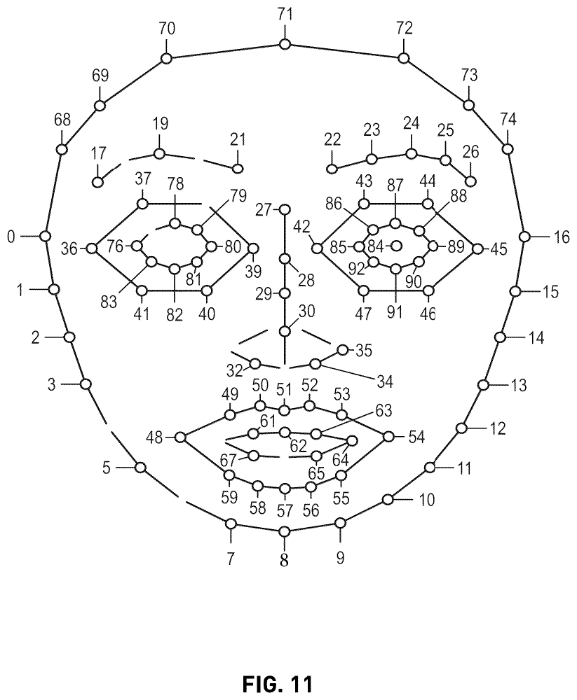

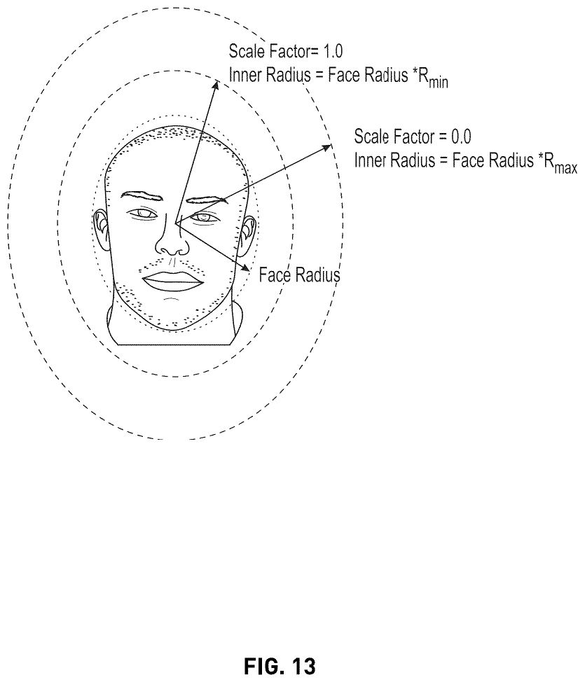

In some examples, the ring size and/or position of the ring shape can be selected or adjusted by the user via a composer widget or ring light widget. In some examples, the ring size and/or position of ring shape are determined based on characteristics of an image portion that includes the detected face. Example characteristics include facial landmarks automatically detected by the face detection and/or tracking module (e.g., shown as numbered points in FIG. 11), or a bounding box for the detected face. The bounding box can be determined based on the automatically detected landmarks, as described at least in FIG. 11 and FIG. 13. The computing device can use the automatically detected facial landmarks and/or the dimensions of the bounding box to compute an inner radius that determines the ring size of the ring shape (see at least FIG. 6 and FIG. 13 for details).

The position of the ring shape can refer to a center position of the ring shape that is determined, as mentioned above, based on the image portion including the detected face. Automatically detected facial landmarks can be used to determine a set of center offset coordinates with respect to the center of the image and/or screen. The center offset coordinates indicate the center position of the ring shape. If the computing device does not detect a face, or if the face detection and/or tracking are deactivated, the center position is set to the center of the image or center of the screen. If the ring light, for example via the ring shape, had already been positioned and/or centered, but needs to be re-centered towards the center of the image or the screen (e.g., due to the deactivation of face detection and/or tracking), the ring light can be re-centered with a predetermined delay (e.g., a 100 milliseconds delay), in order to create a smoother experience for the user.

In some examples, the non-opaque portion of the ring light can be fully transparent, semi-transparent, have a maximum opacity level (over all the corresponding pixels) lower than a predetermined threshold, and so forth. In some examples, the non-opaque portion of the ring light has pixels with the same opacity levels or with varying opacity levels (see FIG. 6 for more details).

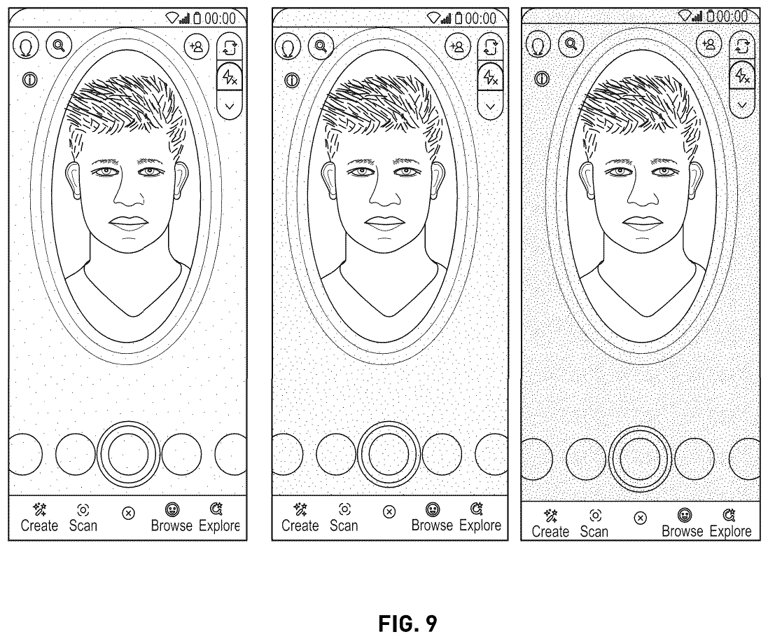

In some examples, the ring light includes a portion of a color of a certain or predetermined lightness, which helps illuminate an object (e.g., a face) detected in the output of the digital image sensor of the camera. Lightness defines a range from dark (0% or fully shaded) to fully illuminated (100% or fully tinted). The portion of a color with a predetermined lightness can cover a predetermined area along the perimeter of the camera view UI (e.g., corresponding to a background area for the ring light), can have a ring shape, can surround, overlap with, or include the non-opaque portion. In some examples, the portion of a color with a predetermined lightness can include multiple lightness levels, which can be automatically selected and/or selected and/or adjusted via a user-selectable UI element. In some examples, the portion of a color with a predetermined lightness can include one or more opaque or almost opaque portions, such as an opaque area along the perimeter of the camera view UI, or an opaque ring shape. The portion of a color with a predetermined lightness can surround, partially or completely, the non-opaque portion, it can be adjacent to the non-opaque portion, and so forth (see, e.g., FIG. 9).

In some examples, the ring light is configured using at least one base color parameter. A base color can correspond to a color of one or more ring light portions, such as a non-opaque portion or a fragment thereof, a portion of a color of predetermined lightness or a fragment thereof, and so forth. Multiple base colors with one or more levels of predetermined lightness can be used for different portions or fragments of the ring light—furthermore, the portions or fragments can have one or more opacity (or transparency) levels. Base color(s) can be preselected, or customized by a user using a UI element such as a slider, color picker, composer widget, ring light widget or other user-actionable UI elements (e.g., see FIG. 6 for additional details).

At operation 508, the computing device causes the display of the ring light over the camera view UI. This operation includes displaying the non-opaque portion including the ring shape with determined ring size and/or centered at a position determined based on characteristics of the image portion including the detected face. In some examples, this operation includes displaying the portion of a color of a predetermined lightness. In some examples, this operation includes displaying additional aspects of the ring light determined as described in the disclosure herein (see, e.g., FIG. 6 below).

The context-aware lighting system 228 can operate independently of several data types not directly pertinent to its function of adjusting the ring size of the ring light. For example, environmental factors like temperature or humidity are not required for ring size control, and neither are the physical orientation and/or position of the device and/or settings related to external lighting equipment. Additionally, the system can be self-contained and not depend on the device's network connectivity or GPS location, or camera settings such as those for video recording or audio capture. The context-aware lighting system 228 can dynamically adjust the virtual ring light based on real-time image analysis that includes the detection of faces within the image and/or their characteristics to optimize photo quality, without the need for external inputs or user-configured settings. Alternatively, one or more of the several data types listed above or additional data types can be used to further configure the ring light. For example, settings predetermined by the user or automatically derived based on user feedback can help personalize the ring size associated with a ring light for a specific user. The context-aware lighting system 228 can elicit, receive, save and/or use custom lighting profiles that can be quickly applied to different scenarios or preferences (e.g., night-time vs. day-time, indoors versus outdoors, formal or informal scenario, etc.). In some examples. The context-aware lighting system 228 can use mood lighting presets that can evoke certain emotions or atmospheres, such as warm tones for a cozy feel or cool tones for a professional look.

In some examples, the system can automatically analyze not just a user face but also background objects by identifying their object type, shapes, sizes and/or colors. The system can further adjust the ring size and/or shape based on the additional identified objects. In some examples, the system can recommend adjustments to a base color based on identified color(s) of the background objects (to match or contrast the identified color(s)).

FIG. 6 is a diagrammatic representation of a view of a context-aware lighting system 228, according to some examples. The context-aware lighting system 228 includes all or some of the depicted components, arranged in the same ways or in a different order. In some examples, the context-aware lighting system 228 includes additional components.

In some examples, the context-aware lighting system 228 uses AR components or experiences (e.g., a “lens”) and/or AR tools such as custom pixel shaders, face detection and/or face tracking to create a customizable ring light lens that implements a customizable ring light. The used AR components and/or AR tools can be provided, for example, by augmentation system 206 or augmentation creation system 214 in FIG. 2.

In some examples, the context-aware lighting system 228 configures color and/or opacity levels of a ring light by determining a RGBA color for pixels in the ring light. The RGBA color for a pixel has an RGB component indicating the color, and an alpha value, or opacity value, indicating the opacity of the pixel. In some examples, the context-aware lighting system 228 uses pixel shader 612 to determine and/or output the final RGBA color for ring light pixels. The pixel shader 612 receives a RGB component value from a base color module 606, and/or an alpha value (or opacity value) from an opacity computation module 608. The base color module 606 receives a base color that determines the RGB component value from a ring light widget 602. The opacity computation module 608 uses a radial gradient module 610 to compute an opacity value by using at least a scale factor (e.g., received from a ring light widget 602), an inner radius, and/or a set of center offset coordinates determined based on a set of facial landmark coordinates (e.g., received from a face detection and/or tracking module 604). As further detailed below, the context-aware lighting system 228 thus uses the opacity computation module 608 to generate a non-opaque portion of the ring light including a ring shape whose ring size and/or center position are determined based on characteristics of the image portion corresponding to the detected face. The context-aware lighting system 228 can use the pixel shader 612, the base color module 606, and/or a brightness (or lightness) setting functionality (e.g., the brightness sub-graph functionality available from the Materials library in Snap's Lens Studio) to generate a portion of the ring light with a color of a predetermined lightness.

### Pixel RGB Value

In some examples, the base color module 606 uses at least one input base color to determine the RGB component value supplied to the pixel shader 612. The at least one input base color can be set to one of a number of default base colors, or be chosen or updated by a user by means of a user-selectable UI element such as a slider, a tone picker, or a color picker that is part of ring light widget 602.

Given the at least one input base color, the base color module 606 can perform color-related transformations to determine the RGB component value. The color-related transformations can include blending multiple supplied base colors, or blending a base color with an additional tone or color. For example, the base color module 606 can use a tone parameter with values such as “cold”, “warm”, or “neutral” to modify one of a set of base colors. Tones, or colors included in a set for the user to select amongst can be configured, ranked or recommended to compliment a particular user's skin tone, or a wide variety of user skin tones.

In some examples, the base color module 606 and/or pixel shader 612 can automatically adjust the lightness or brightness of a pixel's RGB component value. In some examples, this can be done by automatically modifying (increasing, reducing, multiplying or dividing) the R, G, B values by a pre-determined constant or percentage. In some examples, the base color module 606 and/or pixel shader 612 can convert the RGB component to the HSL (Hue, Saturation, Lightness) color space, directly modify the lightness value and convert back to the RGB space. By adjusting the lightness or brightness of pixels' RGB component values, the context-aware lighting system 228 can generate one or more portions of the ring light with a color of a pre-determined lightness.

### Pixel Opacity

In some examples, the opacity computation module 608 configures the appearance of the ring light by determining or adjusting opacity values for one or more of the ring light pixels. The opacity computation module 608 takes as input a scale factor from the ring light widget 602. The opacity computation module 608 takes as input a set of facial landmark coordinates from face detection and/or tracking module 604 (see, e.g., FIG. 11 for example facial landmarks). The opacity computation module 608 determines the opacity values using a radial gradient module 610 that uses a radial gradient computation to adjust the opacity value (the alpha value) of pixels. Opacity value computation for a given pixel uses one or more of a first opacity value, a second opacity value, an inner radius, a set of center offset coordinates, a scale factor, a softness value, or other parameters.

Radial gradient computations are graphical computations that can interpolate values (e.g., color values and/or opacity values) between two circles, from an inner circle boundary associated with an inner radius to an outer circle boundary associated with an outer radius. The inner and outer circles can be concentric. In some examples, additional concentric circles can be used. A radial gradient computation can take as input a sequence of values, including at least a first value corresponding to the inner circle and a second value corresponding to the outer circle. In some examples, additional values in the sequence correspond to additional circles. The radial gradient computation calculates a value for a pixel based on at least the first value, the second value and/or the relative distance of the pixel from the center of the two circles. In some examples, radial gradient computations can also take as input an inner radius, a first value, a second value, and/or other parameters controlling the rate of change from the first value to the second value (e.g., a softness value, etc.). In some examples, the inner radius is a value between 0 and 1. In some examples, an outer radius can be a value between 0 and 1. In some examples, the outer radius can be set to 1, allowing for the inner radius to control the start of the color transition or opacity transition. In some examples, the outer radius can be automatically determined based on the inner radius, and/or omitted. In some examples, radial gradient computations can result in one or more ellipse shapes rather than circle shapes. For examples, the radial gradient computation can take inputs associated with an ellipse width and/or ellipse height. In some examples, the radial gradient computation can automatically use a specified inner radius and a selected “ellipse” setting to derive a height and width for an ellipse (e.g., by constructing a second radius via multiplication by a pre-set factor, etc.).

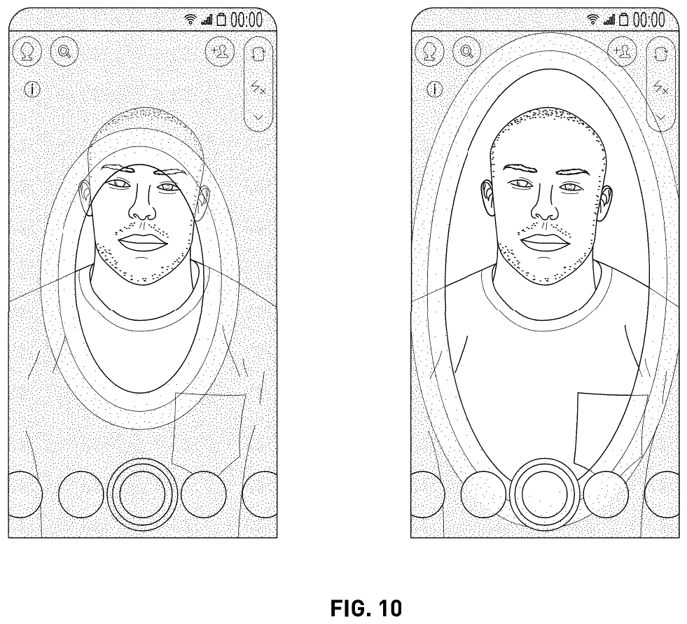

In the context of the ring light's appearance, the radial gradient module 610 enables a transition from the first opacity value to the second opacity value along a direction of increasing distance from a point given by the center offset coordinates (e.g., the center offset point). In some examples, the inner radius controls the start of the transition; for example, the first opacity value can be the same from the center offset point to the end of inner radius (in every direction). An example first opacity value is 0%, corresponding to complete transparency or lack of opacity. Alternatively, a first opacity value can correspond to a high degree of transparency (e.g., indicated by a 2%, 3%, 4%/etc. opacity value). An example second opacity value can be 100%, corresponding to complete opacity, or lack of transparency. Therefore, the radial gradient module 610 can generate a non-opaque portion of a ring light including a ring shape whose ring size is determined based on an inner radius (see, e.g., FIG. 10, for two examples of ring lights based on different inner radius values). In some examples, the non-opaque portion can overlap with or be surrounded by a portion of a color of a predetermined lightness (e.g., see above for computing RGB component values and/or determining color lightness). As mentioned above, the ring shape can be a circle, an ellipse, or another shape. In some examples, the context-aware lighting 228 can modify a shape produced using a radial gradient computation in one or more post-processing operations to resize it, or to impose a different pre-selected shape such as a triangle, rectangle, star, diamond, and so forth.

In some examples, the softness value parameter controls the smoothness/sharpness of the transition from the first opacity value to the second opacity value. For example, the lower the softness value, the sharper or more abrupt the transition will be.

In some examples, the center offset coordinates and/or inner radius are automatically determined based on characteristics of an image portion including the detected face, such as the facial landmark coordinates illustrated in FIG. 11. For example, the center offset coordinates can be chosen to be those of landmark no. 27, or those of landmark no. 30. In some examples, the inner radius is computed based on an automatically determined face radius computed based on the facial landmark coordinates as further detailed in FIG. 13.

In some examples, the ring size of the ring shape can be further based on a scale factor parameter that multiplies the inner radius parameter. The scale factor parameter can be pre-set, or selected and/or adjusted by means of a user-selectable element such as a scale factor slider (e.g. in ring light widget 602). The scale factor value can be inversely proportional to the value of the inner radius. The scale factor value can be a value between 0.0 and 1.0.

In some examples, the radial gradient module 610 uses the Radial-Gradient computation in the Sub-graph Library in Snap's Lens Studio. In some examples, the radial gradient module 610 can use additional radial gradient computation, such as the RadialGradient class from the android.graphics library, radial gradient classes from System. Windows. Media, and so forth.

In some examples, the context-aware lighting system 228 can use multiple pixel shaders, each determining and outputting RGBA colors for different or overlapping subsets of pixels in the ring light. Multiple base color modules and/or opacity computation modules can be used, each of multiple pixel shaders receiving RGB component and, respectively, opacity value inputs from additional base color modules and/or opacity computation modules. RGBA color(s) for one or more pixels in the ring light can be computed by one or more multiple pixel shaders, whose outputs are combined using one more combination function(s) (e.g., MIN, AVG, and other combination functions).

In some examples, the radial gradient can be adjusted based on detected ambient light or environmental factors, ensuring that the lighting enhancement remains of good quality in varying conditions. In some examples, the context-aware lighting system 228 enables the user to control the gradient directly within the UI—for example, users can customize the lighting effects according to their preferences, making the camera UI more user-friendly and/or personalized. In some examples, the lighting system 228 incorporates blending modes, allowing the radial gradient to interact with the content in various ways, such as softening the light or creating dramatic effects.

Single and/or Multiple Face Detection

As seen above, the facial landmark coordinates used by opacity computation module 608 can be supplied by a face detection and/or tracking module 604. The face detection and/or tracking module 604 detects a face in an image corresponding to the output of a digital sensor of a camera, and/or computes characteristics of the image portion including the detected face. The face detection and/or tracking module 604 can be one or multiple modules (e.g., a module responsible for face detection, a module responsible for face tracking, a module performing both functions, etc.). The face detection and/or tracking module 604 can use functionality provided by an augmentation system 206, such as face tracking functionality. The face detection and/or tracking functionality detects and/or tracks a face, but, for privacy purposes, does not perform face recognition to recognize or track a specific user.

In some examples, the context-aware lighting system 228 can detect a second face in the image corresponding to the output of digital sensor of a camera. If a second face is detected, the opacity computation module 608 uses a second radial gradient module (not shown) with a second set of parameters, including a second center offset point and a second inner radius value. The second inner radius and/or second center offset point can be derived based on the second image portion including the second detected face as described above for the inner radius and/or center offset point in the context of the first detected face. Thus, a second non-opaque portion with a second ring size and a second position can be configured as part of the same ring light or as part of a second ring light. A second portion of a second color with a second predetermined lightness can also be configured, as part of the same ring light, or as part of the second ring light. In some examples the second color and/or second predetermined lightness are the same as the color and/or predetermined lightness for the initial portion. The second portion of the second color with the second predetermined lightness can have properties similar to the first portion—for example, it can be adjacent to, or partially or completely surround the second non-opaque portion, it can be partially or completely opaque, and so forth.

The second radial gradient module can operate independently of or in conjunction with the first radial gradient module.

When using two (or more) radial gradient modules, the opacity computation module 608 can determine the opacity value of a given pixel based on a combination function that uses the opacity values computed by the multiple radial gradient modules. Example combination functions include MIN, AVG, or other combination functions.

By using additional radial gradient modules, the context-aware lighting system 228 configures additional ring lights and/or additional or enlarged non-opaque portions of the ring light based on additional image portions including additional detected faces. FIG. 12 shows an example of when two faces are detected, and a ring light is appropriately configured to not occlude either of the two faces.

In some examples, a ring light implemented, created and/or customized via a ring light lens and/or the use of AR functionality can be configured to have additional texture, aspect and/or motion effects made possible by AR content, effects and/or tools. For example, a ring light lens can include AR effects such as a fog light effect, a shimmering effect, a moving particle effect, or other effects. AR effects could be used to add virtual objects or effects that interact with the lighting, such as reflections or shadows, to create a more immersive experience. In some examples, AR modifications and/or AR content items resulting from applying a ring light lens to a digital image sensor output of a camera can be displayed as part of a preview feature. Such a preview feature corresponds to the AR modifications and/or content items being displayed on a screen of a computing device, but not stored in memory. In some examples, the content captured by digital image sensor, with or without the AR modifications and/or AR content items, can be recorded and/or stored in memory.

In some examples, a ring light can be generated and/or activated via a flash icon or an equivalent user selectable UI element presented in the camera view UI. In the case of a ring light lens, user selection (e.g., via touching of the flash icon), will result in the download and activation of the ring light lens on a computing device as soon as the lens is available. In some examples, the lens-based ring light is displayed in the camera view UI, overlaid for example on top of an image visible in a camera viewfinder or as part of the camera view UI. If the ring light lens is unavailable, a backup ring light can be generated at the camera level and/or presented in the camera view UI.

In some examples, a context-aware lighting system 228 can use a hybrid implementation that combines camera functionality with AR experiences. Such an implementation can use an “empty” lens corresponding to a lens AR experience that does not add any image or sound effects to an image, but is used to access face detection and/or tracking functionality provided by an augmentation system 206 or augmentation creation system 214 (e.g., provided by Snap's Lens Core). The context-aware lighting system 228 uses the results of the face detection and/or tracking to determine an appropriate ring size ensuring that the ring light is not opaque over the detected face or faces. The configured ring light can be rendered directly in the camera. Therefore, a hybrid context-aware lighting system can use a combination of an AR experience as a means of accessing facial awareness-related AR tools, and the camera as a means of rendering the ring light.

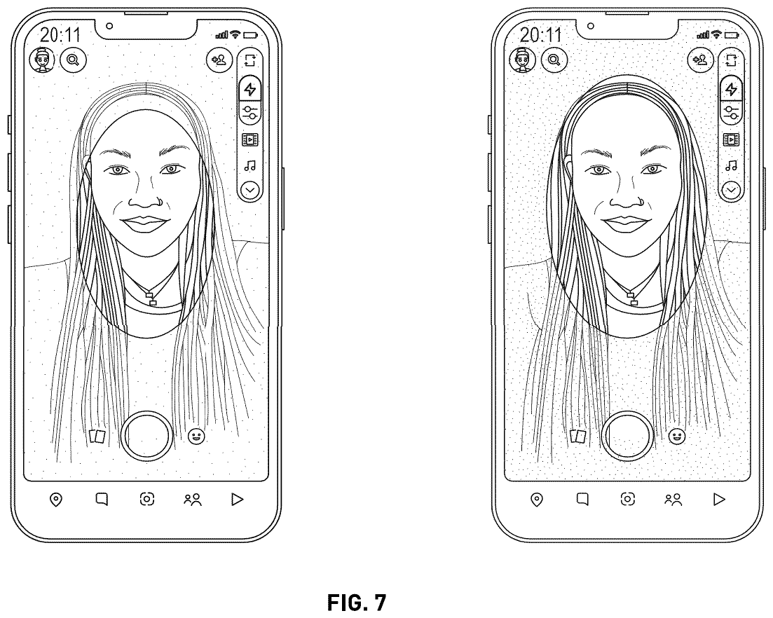

FIG. 7 is an illustration of lighting system outputs, according to some examples. A first example ring light is not face-aware, and thus shows an amount of occlusion of the face present in the image. For example, part of the forehead is occluded. A second example ring light is face-aware, and the face is not occluded.

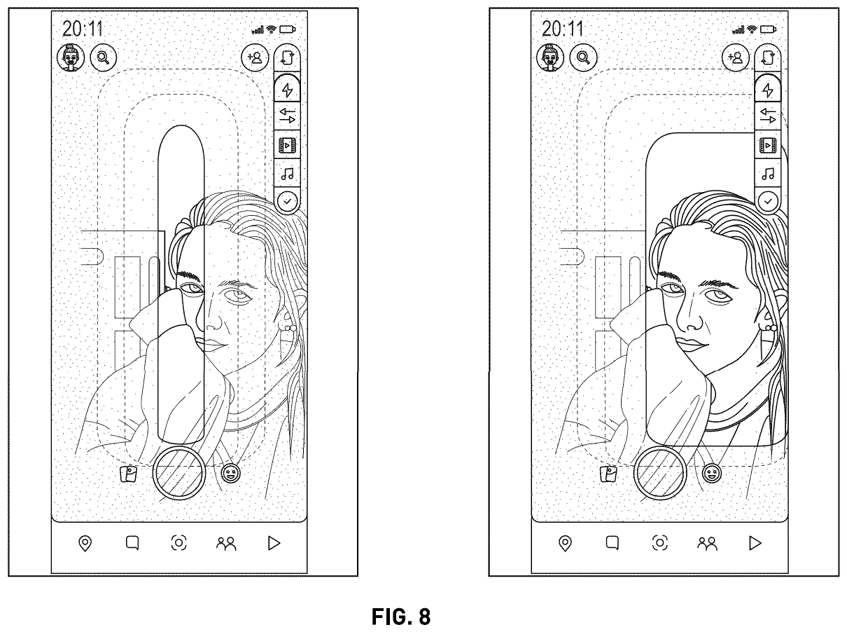

FIG. 8 is an illustration of lighting system outputs, according to some examples. A first panel shows an example of a ring light not benefitting from face detection, and therefore showing occlusion of a present face. A second panel shows a context-aware ring light, the context being the detected face in the image corresponding to the output of the digital image sensor of the camera. As illustrated, the detected face is not occluded by the ring light. FIG. 8 also illustrates the context-aware lighting system 228 accommodating a detected face that is not centrally located.

FIG. 9 is an illustration of lighting system outputs with different base colors, according to some examples. The illustrated ring lights can exhibit not just different base colors, but different textures, materials, patterns, or other.

FIG. 10 is an illustration of lighting system outputs with different ring sizes, according to some examples. A first ring light has a non-opaque portion including an inner ring shape whose size is based on an inner radius of 0.2. A second ring light has a non-opaque portion including an inner ring shape whose size is based on an inner radius of 0.7.

FIG. 11 is an illustration of an output of a face detection and/or tracking module, according to some examples. FIG. 11 illustrates facial landmarks automatically detected during or after the detection of a face in an image. The facial landmarks are indicated by the numbers in the illustration. Context-aware lighting system 228 can use landmark 27, landmark 30, or other landmarks to determine a set of center offset coordinates. The context-aware lighting system 228 can determine the bounding box of the detected face as being indicated by landmarks {0, 16, 8, 71}. As seen in FIG. 13, facial landmarks and/or bounding box information can be used to determine an inner radius that determines the ring size associated with the ring shape in the non-opaque portion of the ring light.

FIG. 12 is an illustration of lighting system outputs, according to some examples. FIG. 12 illustrates ring lights generated in three cases: a case where no face is detected, a case in which one face is detected, and a case in which two faces are detected.

In the first case, the illustrated ring light includes a non-opaque portion centered around the center of the image, The ring light is not context-aware (e.g., facially-aware), as no face was detected.

In the second case, the illustrated ring light is configured based on the characteristics of a detected face. The center position for the ring light's non-opaque portion is determined based on the detected face. The ring light does not occlude the detected face.

In the third case, the illustrated ring light accommodates an additional detected face by configuring an additional non-opaque portion corresponding to the additional image area including the additional detected face. The additional non-opaque portion is centered around an additional center position determined based on characteristics of the additional detected face. In some examples, more than two faces are detected, and the ring light is configured accordingly.

FIG. 13 illustrates examples of different ring sizes in the context of a detected face, according to some examples. FIG. 13 shows how the output of the face detection and/or tracking module can be used to determine the ring size of the ring shape included in the non-opaque portion of a ring light. During or after the detection of a face by the face detection and/or tracking module 604, a set of facial landmarks and their coordinates are detected (see, e.g., FIG. 11). A bounding box for the detected face can be computed (see, e.g., FIG. 11 for details). Given the bounding box, the context-aware lighting system 228 computes the value of a face radius as a function of the horizontal length and vertical length corresponding to the bounding box (e.g., using an average, a weighted average, or other functions). The context-aware lighting system 228 computes an inner radius by multiplying the face radius value using a scale factor (e.g., Rₘᵢₙ or Rₘₐₓ.). The scale factor can be pre-set and/or received via a user selection. In some examples, the scale factor can be automatically interpolated between two values Rₘᵢₙ and Rₘₐₓ (see the illustration in FIG. 13). Multiplying the face radius by the scale factor can create a margin from the user's face (see FIG. 13).

In some examples, more than one scale factor can be used—for example, a first scale factor can be used to compute the inner radius while a second scale factor can be received via user selection and be used to further adjust the ring size. Thus, the inner radius and/or one or more scale factors are used by the context-aware lighting system 228 to determine or adjust a ring size (e.g., a circle size, an ellipse size) for a ring shape in the non-opaque portion of a ring light. For example, the system can set the opacity value for each pixel within the inner radius in each direction to 0% (or another low opacity value such as 1%, 2%, etc.). In some examples, the inner radius is used by the opacity computation module 608, as described in FIG. 6, to configure the ring light by varying pixel opacity values, with the inner radius and/or a scale factor being used to control the ring size of a ring shape included in the non-opaque portion.

### Time-Based Access Architecture

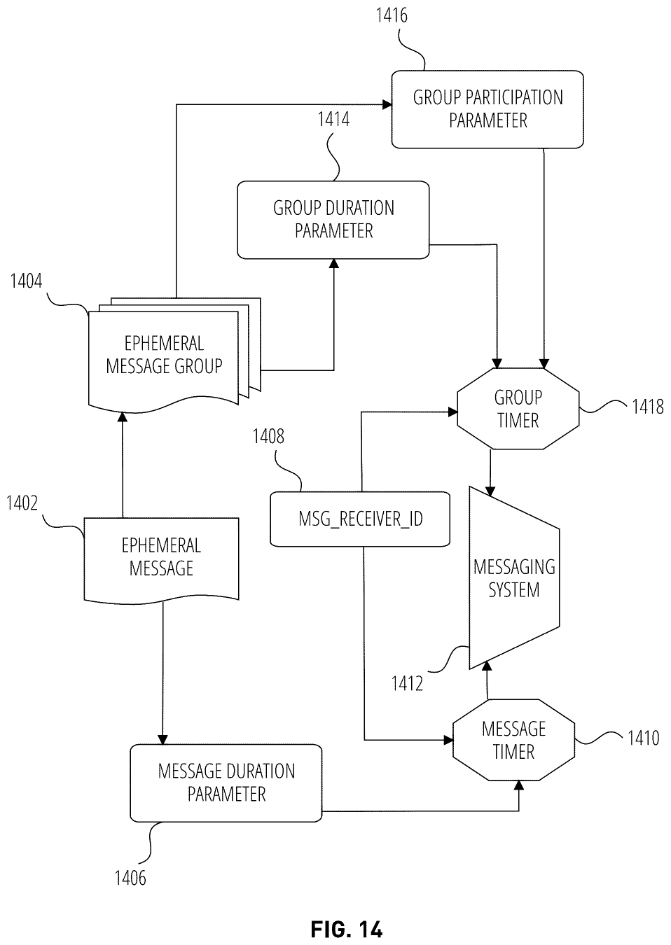

FIG. 14 is a schematic diagram illustrating an access-limiting process, in terms of which access to content (e.g., an ephemeral message 1402 and associated multimedia payload of data) or a content collection (e.g., an ephemeral message group 1404) may be time-limited (e.g., made ephemeral).

An ephemeral message 1402 is shown to be associated with a message duration parameter 1406, the value of which determines the amount of time that the ephemeral message 1402 will be displayed to a receiving user of the ephemeral message 1402 by the interaction client 104. In some examples, an ephemeral message 1402 is viewable by a receiving user for up to a maximum of 10 seconds, depending on the amount of time that the sending user specifies using the message duration parameter 1406.

The message duration parameter 1406 and the message receiver identifier 1408 are shown to be inputs to a message timer 1410, which is responsible for determining the amount of time that the ephemeral message 1402 is shown to a particular receiving user identified by the message receiver identifier 1408. In particular, the ephemeral message 1402 will be shown to the relevant receiving user for a time period determined by the value of the message duration parameter 1406. The message timer 1410 is shown to provide output to a more generalized messaging system 1412, which is responsible for the overall timing of display of content (e.g., an ephemeral message 1402) to a receiving user.

The ephemeral message 1402 is shown in FIG. 14 to be included within an ephemeral message group 1404 (e.g., a collection of messages in a personal story, or an event story). The ephemeral message group 1404 has an associated group duration parameter 1414, a value of which determines a time duration for which the ephemeral message group 1404 is presented and accessible to users of the interaction system 100. The group duration parameter 1414, for example, may be the duration of a music concert, where the ephemeral message group 1404 is a collection of content pertaining to that concert. Alternatively, a user (either the owning user or a curator user) may specify the value for the group duration parameter 1414 when performing the setup and creation of the ephemeral message group 1404.

Additionally, each ephemeral message 1402 within the ephemeral message group 1404 has an associated group participation parameter 1416, a value of which determines the duration of time for which the ephemeral message 1402 will be accessible within the context of the ephemeral message group 1404. Accordingly, a particular ephemeral message group 1404 may “expire” and become inaccessible within the context of the ephemeral message group 1404 prior to the ephemeral message group timer itself expiring in terms of the group duration parameter. The group duration parameter 1414, group participation parameter 1416 and message receiver identifier 1408 each provide input to a group timer 1418, which operationally determines, firstly, whether a particular ephemeral message 1402 of the ephemeral message group 1404 will be displayed to a particular receiving user and, if so, for how long. Note that the ephemeral message group 1404 is also aware of the identity of the particular receiving user as a result of the message receiver identifier 1408.

Accordingly, the group timer 1418 operationally controls the overall lifespan of an associated ephemeral message group 1404 as well as an individual ephemeral message 1402 included in the ephemeral message group 1404. In some examples, each and every ephemeral message 1402 within the ephemeral message group 1404 remains viewable and accessible for a time period specified by the group duration parameter 1414. In a further example, a certain ephemeral message 1402 may expire within the context of ephemeral message group 1404 based on a group participation parameter 1416. Note that a message duration parameter 1406 may still determine the duration of time for which a particular ephemeral message 1402 is displayed to a receiving user, even within the context of the ephemeral message group 1404. Accordingly, the message duration parameter 1406 determines the duration of time that a particular ephemeral message 1402 is displayed to a receiving user regardless of whether the receiving user is viewing that ephemeral message 1402 inside or outside the context of an ephemeral message group 1404.

The messaging system 1412 may furthermore operationally remove a particular ephemeral message 1402 from the ephemeral message group 1404 based on a determination that it has exceeded an associated group participation parameter 1416. For example, when a sending user has established a group participation parameter 1416 of 24 hours from posting, the messaging system 1412 will remove the relevant ephemeral message 1402 from the ephemeral message group 1404 after the specified 24 hours. The messaging system 1412 also operates to remove an ephemeral message group 1404 when either the group participation parameter 1416 for each and every ephemeral message 1402 within the ephemeral message group 1404 has expired, or when the ephemeral message group 1404 itself has expired in terms of the group duration parameter 1414.

In certain use cases, a creator of a particular ephemeral message group 1404 may specify an indefinite group duration parameter 1414. In this case, the expiration of the group participation parameter 1416 for the last remaining ephemeral message 1402 within the ephemeral message group 1404 will determine when the ephemeral message group 1404 itself expires. In this case, a new ephemeral message 1402, added to the ephemeral message group 1404 with a new group participation parameter 1416, effectively extends the life of an ephemeral message group 1404 to equal the value of the group participation parameter 1416.

Responsive to the messaging system 1412 determining that an ephemeral message group 1404 has expired (e.g., is no longer accessible), the messaging system 1412 communicates with the interaction system 100 (and, for example, specifically the interaction client 104) to cause an indicium (e.g., an icon) associated with the relevant ephemeral message group 1404 to no longer be displayed within a user interface of the interaction client 104. Similarly, when the messaging system 1412 determines that the message duration parameter 1406 for a particular ephemeral message 1402 has expired, the messaging system 1412 causes the interaction client 104 to no longer display an indicium (e.g., an icon or textual identification) associated with the ephemeral message 1402.

### Machine Architecture

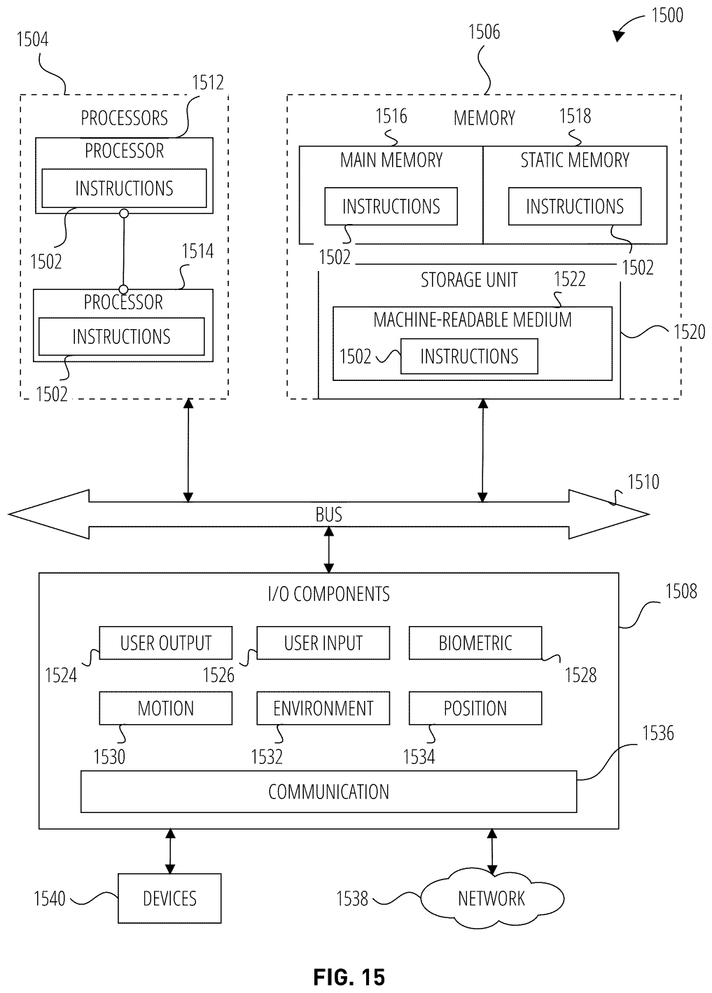

FIG. 15 is a diagrammatic representation of the machine 1500 within which instructions 1502 (e.g., software, a program, an application, an applet, an app, or other executable code) for causing the machine 1500 to perform any one or more of the methodologies discussed herein may be executed. For example, the instructions 1502 may cause the machine 1500 to execute any one or more of the methods described herein. The instructions 1502 transform the general, non-programmed machine 1500 into a particular machine 1500 programmed to carry out the described and illustrated functions in the manner described. The machine 1500 may operate as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1502, sequentially or otherwise, that specify actions to be taken by the machine 1500. Further, while a single machine 1500 is illustrated, the term “machine” shall also be taken to include a collection of machines that individually or jointly execute the instructions 1502 to perform any one or more of the methodologies discussed herein. The machine 1500, for example, may comprise the user system 102 or any one of multiple server devices forming part of the interaction server system 110. In some examples, the machine 1500 may also comprise both client and server systems, with certain operations of a particular method or algorithm being performed on the server-side and with certain operations of the particular method or algorithm being performed on the client-side.

The machine 1500 may include processors 1504, memory 1506, and input/output I/O components 1508, which may be configured to communicate with each other via a bus 1510. In an example, the processors 1504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1512 and a processor 1514 that execute the instructions 1502. The term “processor” is intended to include multi-core processors that may comprise two or more independent processors (sometimes referred to as “cores”) that may execute instructions contemporaneously. Although FIG. 15 shows multiple processors 1504, the machine 1500 may include a single processor with a single-core, a single processor with multiple cores (e.g., a multi-core processor), multiple processors with a single core, multiple processors with multiples cores, or any combination thereof.

The memory 1506 includes a main memory 1516, a static memory 1518, and a storage unit 1520, both accessible to the processors 1504 via the bus 1510. The main memory 1506, the static memory 1518, and storage unit 1520 store the instructions 1502 embodying any one or more of the methodologies or functions described herein. The instructions 1502 may also reside, completely or partially, within the main memory 1516, within the static memory 1518, within machine-readable medium 1522 within the storage unit 1520, within at least one of the processors 1504 (e.g., within the processor's cache memory), or any suitable combination thereof, during execution thereof by the machine 1500.

The I/O components 1508 may include a wide variety of components to receive input, provide output, produce output, transmit information, exchange information, capture measurements, and so on. The specific I/O components 1508 that are included in a particular machine will depend on the type of machine. For example, portable machines such as mobile phones may include a touch input device or other such input mechanisms, while a headless server machine will likely not include such a touch input device. It will be appreciated that the I/O components 1508 may include many other components that are not shown in FIG. 15. In various examples, the I/O components 1508 may include user output components 1524 and user input components 1526. The user output components 1524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1508 may include biometric components 1528, motion components 1530, environmental components 1532, or position components 1534, among a wide array of other components. For example, the biometric components 1528 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1530 include acceleration sensor components (e.g., accelerometer), gravitation sensor components, rotation sensor components (e.g., gyroscope).

The environmental components 1532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1534 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1508 further include communication components 1536 operable to couple the machine 1500 to a network 1538 or devices 1540 via respective coupling or connections. For example, the communication components 1536 may include a network interface component or another suitable device to interface with the network 1538. In further examples, the communication components 1536 may include wired communication components, wireless communication components, cellular communication components, Near Field Communication (NFC) components, Bluetooth® components (e.g., Bluetooth Low Energy), Wi-Fix components, and other communication components to provide communication via other modalities. The devices 1540 may be another machine or any of a wide variety of peripheral devices (e.g., a peripheral device coupled via a USB).

Moreover, the communication components 1536 may detect identifiers or include components operable to detect identifiers. For example, the communication components 1536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1536, such as location via Internet Protocol (IP) geolocation, location via Wi-Fi® signal triangulation, location via detecting an NFC beacon signal that may indicate a particular location, and so forth.

The various memories (e.g., main memory 1516, static memory 1518, and memory of the processors 1504) and storage unit 1520 may store one or more sets of instructions and data structures (e.g., software) embodying or used by any one or more of the methodologies or functions described herein. These instructions (e.g., the instructions 1502), when executed by processors 1504, cause various operations to implement the disclosed examples.

The instructions 1502 may be transmitted or received over the network 1538, using a transmission medium, via a network interface device (e.g., a network interface component included in the communication components 1536) and using any one of several well-known transfer protocols (e.g., hypertext transfer protocol (HTTP)). Similarly, the instructions 1502 may be transmitted or received using a transmission medium via a coupling (e.g., a peer-to-peer coupling) to the devices 1540.

### Software Architecture

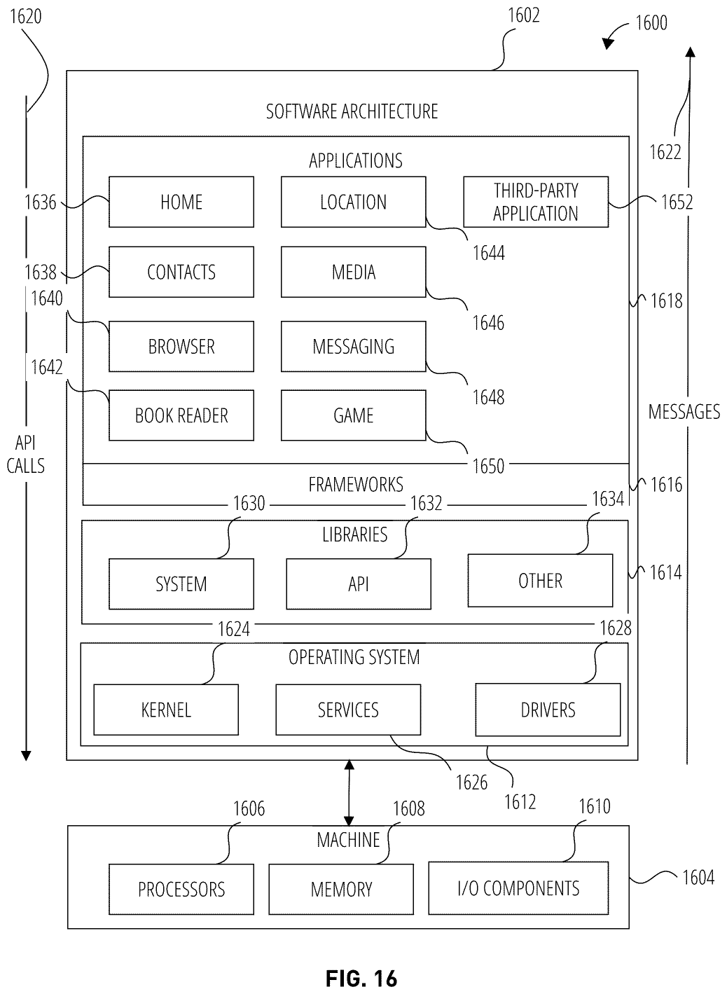

FIG. 16 is a block diagram 1600 illustrating a software architecture 1602, which can be installed on any one or more of the devices described herein. The software architecture 1602 is supported by hardware such as a machine 1604 that includes processors 1606, memory 1608, and I/O components 1610. In this example, the software architecture 1602 can be conceptualized as a stack of layers, where each layer provides a particular functionality. The software architecture 1602 includes layers such as an operating system 1612, libraries 1614, frameworks 1616, and applications 1618. Operationally, the applications 1618 invoke API calls 1620 through the software stack and receive messages 1622 in response to the API calls 1620.

The operating system 1612 manages hardware resources and provides common services. The operating system 1612 includes, for example, a kernel 1624, services 1626, and drivers 1628. The kernel 1624 acts as an abstraction layer between the hardware and the other software layers. For example, the kernel 1624 provides memory management, processor management (e.g., scheduling), component management, networking, and security settings, among other functionalities. The services 1626 can provide other common services for the other software layers. The drivers 1628 are responsible for controlling or interfacing with the underlying hardware. For instance, the drivers 1628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1614 provide a common low-level infrastructure used by the applications 1618. The libraries 1614 can include system libraries 1630 (e.g., C standard library) that provide functions such as memory allocation functions, string manipulation functions, mathematic functions, and the like. In addition, the libraries 1614 can include API libraries 1632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1614 can also include a wide variety of other libraries 1634 to provide many other APIs to the applications 1618.

The frameworks 1616 provide a common high-level infrastructure that is used by the applications 1618. For example, the frameworks 1616 provide various graphical user interface (GUI) functions, high-level resource management, and high-level location services. The frameworks 1616 can provide a broad spectrum of other APIs that can be used by the applications 1618, some of which may be specific to a particular operating system or platform.

In an example, the applications 1618 may include a home application 1636, a contacts application 1638, a browser application 1640, a book reader application 1642, a location application 1644, a media application 1646, a messaging application 1648, a game application 1650, and a broad assortment of other applications such as a third-party application 1652. The applications 1618 are programs that execute functions defined in the programs. Various programming languages can be employed to create one or more of the applications 1618, structured in a variety of manners, such as object-oriented programming languages (e.g., Objective-C, Java, or C++) or procedural programming languages (e.g., C or assembly language). In a specific example, the third-party application 1652 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1652 can invoke the API calls 1620 provided by the operating system 1612 to facilitate functionalities described herein.

### Examples

Example 1 is a computer-implemented method comprising: causing presentation of a camera view user interface (UI) on a computing device, the camera view UI comprising an output of a digital image sensor of a camera; detecting a face in an image corresponding to the output of the digital image sensor of the camera; in response to detecting the face, generating a ring light comprising: a non-opaque portion comprising a ring shape with a ring size and a position determined based on an image portion comprising the detected face; and a portion of a color with a predetermined lightness; and causing display, on the computing device, of the ring light over the camera view UI.

In Example 2, the subject matter of Example 1 includes, wherein generating the ring light further comprises configuring at least one of the non-opaque portion and the portion of the color of the predetermined lightness using a base color.

In Example 3, the subject matter of Example 2 includes, computing coordinates of facial landmarks based on the detected face, and wherein determining the ring size of the ring shape uses an inner radius computed based on the coordinates of the facial landmarks.

In Example 4, the subject matter of Example 3 includes, generating a set of center offset coordinates based on the coordinates of facial landmarks, and wherein determining the position of the ring shape is further based on the set of center offset coordinates.

In Example 5, the subject matter of Examples 3-4 includes, wherein computing the inner radius is further based on a value selected via a scale factor slider displayed on the computing device.

In Example 6, the subject matter of Examples 2-5 includes, displaying user selectable elements actionable to select the base color or the ring size.

In Example 7, the subject matter of Examples 3-6 includes, wherein computing the inner radius further comprises: determining a scale factor value by interpolating between a predetermined maximum value and a predetermined minimum value; determining a face radius based on the coordinates of facial landmarks; computing the inner radius by multiplying the scale factor value and the face radius.

In Example 8, the subject matter of Examples 1-7 includes, wherein the portion of the color with the predetermined lightness is opaque along a perimeter of the camera view UI.

In Example 9, the subject matter of Examples 1-8 includes, wherein the portion of the color with the predetermined lightness is nearly adjacent to the non-opaque portion or surrounds the non-opaque portion.

In Example 10, the subject matter of Examples 4-9 includes, wherein generating the ring light further comprises computing a RGBA color value for each of a plurality of pixels of the ring light, and wherein: the RGBA color value for each pixel comprises a RGB component value and an opacity value; the RGB component value is computed using the base color; and the opacity value is computed using at least one of the inner radius, the set of center offset coordinates, or a radial gradient computation.

In Example 11, the subject matter of Examples 1-10 includes, detecting a second face in the image corresponding to the output of the digital image sensor of the camera; configuring the ring light to further include: a second non-opaque portion comprising a second ring shape with a second ring size and a second position determined based on a second image portion comprising the second face; and a second portion of a second color with a second predetermined lightness; and causing display, on the computing device, of the ring light over the camera view UI.

In Example 12, the subject matter of Example 11 includes, wherein the second portion of the second color with the second predetermined lightness is nearly adjacent to the second non-opaque portion.

In Example 13, the subject matter of Examples 7-12 includes, wherein determining the face radius further comprises: generating a bounding box based on the coordinates of computed facial landmarks; computing the face radius based on a length and a width of the bounding box.

Example 14 is at least one machine-readable medium including instructions that, when executed by processing circuitry, cause the processing circuitry to perform operations to implement of any of Examples 1-13.

Example 15 is an apparatus comprising means to implement of any of Examples 1-13.

Example 16 is a system to implement of any of Examples 1-13.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any computing device or machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A computer-implemented method comprising:
causing presentation of a camera view user interface (UI) on a computing device, the camera view UI comprising an output of a digital image sensor of a camera;
detecting a face in an image corresponding to the output of the digital image sensor of the camera;
in response to detecting the face, generating a ring light comprising:
a non-opaque portion comprising a ring shape with a ring size and a position determined based on an image portion comprising the detected face; and
a portion of a color with a predetermined lightness; and
causing display, on the computing device, of the ring light over the camera view UI.

2. The computer-implemented method of claim 1, wherein generating the ring light further comprises configuring at least one of the non-opaque portion and the portion of the color with the predetermined lightness using a base color.

3. The computer-implemented method of claim 2, further comprising computing coordinates of facial landmarks based on the detected face, and wherein determining the ring size of the ring shape uses an inner radius computed based on the coordinates of the facial landmarks.

4. The computer-implemented method of claim 3, further comprising generating a set of center offset coordinates based on the coordinates of facial landmarks, and wherein determining the position of the ring shape is further based on the set of center offset coordinates.

5. The computer-implemented method of claim 3, wherein computing the inner radius is further based on a value selected via a scale factor slider displayed on the computing device.

6. The computer-implemented method of claim 2, further comprising displaying user selectable elements actionable to select the base color or the ring size.

7. The computer-implemented method of claim 3, wherein computing the inner radius further comprises:
determining a scale factor value by interpolating between a predetermined maximum value and a predetermined minimum value;
determining a face radius based on the coordinates of facial landmarks;
computing the inner radius by multiplying the scale factor value and the face radius.

8. The computer-implemented method of claim 1, wherein the portion of the color with the predetermined lightness is opaque along a perimeter of the camera view UI.

9. The computer-implemented method of claim 1, wherein the portion of the color with the predetermined lightness is nearly adjacent to the non-opaque portion or surrounds the non-opaque portion.

10. The computer-implemented method of claim 4, wherein generating the ring light further comprises computing a RGBA color value for each of a plurality of pixels of the ring light, and wherein:
the RGBA color value for each pixel comprises a RGB component value and an opacity value;
the RGB component value is computed using the base color; and
the opacity value is computed using at least one of the inner radius, the set of center offset coordinates, or a radial gradient computation.

11. The computer-implemented method of claim 1, further comprising:
detecting a second face in the image corresponding to the output of the digital image sensor of the camera;
configuring the ring light to further include:
a second non-opaque portion comprising a second ring shape with a second ring size and a second position determined based on a second image portion comprising the second face; and
a second portion of a second color with a second predetermined lightness; and
causing display, on the computing device, of the ring light over the camera view UI.

12. The computer-implemented method of claim 11, wherein the second portion of the second color with the second predetermined lightness is nearly adjacent to the second non-opaque portion.

13. The computer-implemented method of claim 7, wherein determining the face radius further comprises:
generating a bounding box based on the coordinates of computed facial landmarks;
computing the face radius based on a length and a width of the bounding box.

14. A computing apparatus comprising:
at least one processor; and
a memory storing instructions that, when executed by the at least one processor, configure the apparatus to:
cause presentation of a camera view user interface (UI) on a computing device, the camera view UI comprising an output of a digital image sensor of a camera;
detect a face in an image corresponding to the output of the digital image sensor of the camera;
in response to detecting the face, generate a ring light comprising:
a non-opaque portion comprising a ring shape with a ring size and a position determined based on an image portion comprising the detected face; and
a portion of a color with a predetermined lightness; and
cause display, on the computing device, of the ring light over the camera view UI.

15. The computing apparatus of claim 14, wherein generating the ring light further comprises configuring at least one of the non-opaque portion and the portion of the color with the predetermined lightness using a base color.

16. The computing apparatus of claim 15, further comprising computing coordinates of facial landmarks based on the detected face, and wherein determining the ring size of the ring shape uses an inner radius computed based on the coordinates of the facial landmarks.

17. The computing apparatus of claim 16, further comprising generating a set of center offset coordinates based on the coordinates of facial landmarks, and wherein determining the position of the ring shape is further based on the set of center offset coordinates.

18. The computing apparatus of claim 17, wherein computing the inner radius is further based on a value selected via a scale factor slider displayed on the computing device.

19. The computing apparatus of claim 15, further comprising displaying user selectable elements actionable to select the base color or the ring size.

20. A non-transitory computer-readable storage medium storing instructions that, when executed by at least one processor, cause the at least one processor to perform operations comprising:
causing presentation of a camera view user interface (UI) on a computing device, the camera view UI comprising an output of a digital image sensor of a camera;
detecting a face in an image corresponding to the output of the digital image sensor of the camera;
in response to detecting the face, generating a ring light comprising:
a non-opaque portion comprising a ring shape with a ring size and a position determined based on an image portion comprising the detected face; and
a portion of a color with a predetermined lightness; and
causing display, on the computing device, of the ring light over the camera view UI.
